(19) United States
(12) Patent Application Publication
(10) Pub. No.: US 2026/0171588 A1
(43) Pub. Date: Jun. 18, 2026

(54) CHAIN-LINKED CYLINDRICAL BATTERY CELL FOR BATTERY PACKS

(71) Applicants: HYUNDAI MOTOR COMPANY, SEOUL (KR); KIA CORPORATION, SEOUL (KR)

(72) Inventor: Tae Jin Kim, Hwaseong-si (KR)

(73) Assignees: HYUNDAI MOTOR COMPANY, SEOUL (KR); KIA CORPORATION, SEOUL (KR)

(21) Appl. No.: 19/197,323

(22) Filed: May 2, 2025

(30) Foreign Application Priority Data
Dec. 17, 2024 (KR) 10-2024-0189065

(51) Int. Cl. H01M 50/291; B60L 50/60; H01M 50/213; H01M 50/249; H01M 50/262; H01M 50/271; H01M 50/293

(52) U.S. Cl. CPC H01M 50/291; H01M 50/213; H01M 50/249; H01M 50/262; H01M 50/271; H01M 50/293; B60L 50/60; H01M 2220/20

(57) ABSTRACT

A chain-linked cylindrical battery cell includes a cylindrical can sealed by a top cap. The cylindrical can is configured to house a jelly-roll and electrolyte. The chain-linked cylindrical battery cell further includes a first chain ring configured to attach to an upper end of the cylindrical can, and a second chain ring configured to attach to a lower end of the cylindrical can. Each ring includes a pair of coupling rings protruding in opposite directions. Additionally, the chain-linked cylindrical can includes a chain pin configured to be inserted through the coupling rings, aligned with a longitudinal axis of the cylindrical can. The configuration allows adjacent similarly-structured chain-linked cylindrical battery cells to be rotatably connected, forming a chain-like structure suitable for battery packs.

### CROSS-REFERENCE TO RELATED APPLICATION(S)

This application claims the benefit of and priority to Korean Patent Application No. 10-2024-0189065, filed on Dec. 17, 2024, in the Korean Intellectual Property Office, the disclosure of which is herein incorporated by reference in its entirety.

### TECHNICAL FIELD

The present disclosure relates to a chain-linked cylindrical battery cell for battery packs. More particularly, the present disclosure relates to a chain-linked cylindrical battery cell configured such that a plurality of cylindrical battery cells is interconnected in the form of a chain.

### BACKGROUND

A battery cell that can be used repeatedly by charging and discharging refers to an electrochemical energy storage apparatus that is widely used in various industries, such as electric vehicles, energy storage systems (ESSs), and small electronic devices.

The battery cell that can be repeatedly charged and discharged has evolved from the development of Voltaic cells in the 19th century to the current form of lithium-ion batteries.

In the early days, lead-acid batteries and nickel-cadmium (NiCd) batteries were mainly used, but with the commercialization of lithium-ion batteries with excellent energy density and long life in the 1990s, lithium-ion batteries became an essential energy storage apparatus for various industries. Since then, battery cells with high output and high efficiency have been developed and used in various shapes such as cylindrical, pouch, and prismatic shapes.

For example, a cylindrical battery cell refers to a battery cell configured such that a metal cylindrical can, in which a jelly-roll comprising a positive electrode, a negative electrode, and a separator wound in the form of a roll is received, is filled with an electrolyte and an upper end of the metal cylindrical can is sealed.

Due to the use of the metal cylindrical can, the cylindrical battery cell is mechanically shock-resistant and rigid. Additionally, the cylindrical battery cell may be mass-produced through automation, and has the advantage of high energy density and stable output.

When a battery pack is manufactured using a large number of cylindrical battery cells so as to be applied to a high-output electric vehicle or an energy storage system (ESS), disadvantages may occur such as: 1) a large amount of labor required to align the cylindrical battery cells in a battery pack frame one by one and to electrically connect the cylindrical battery cells to each other; 2) difficulty in identifying and replacing failed battery cells; and 3) easy electrical contact separation or short circuit of some of the battery cells due to external impact.

A pouch-shaped battery cell, which is a thin cuboidal battery cell in which battery materials, such as a positive electrode, a negative electrode, a separator, and an electrolyte, are sealed with a metal or plastic film, has the advantage of being lightweight, configurable in various sizes, and having high energy density with high space efficiency. However, the pouch-shaped battery cell also has the disadvantage of being vulnerable to shock and pressure, requiring an outer case for mechanical protection, and, when used to constitute a battery pack, requires a lot of labor to align and electrically connect the pouch-shaped battery cells as in the case of the cylindrical battery cell, resulting in a decrease in manufacturing efficiency.

Therefore, there is a desire for research and development to enhance the efficiency of manufacturing or assembly in constructing a battery pack by aligning and disposing cylindrical or pouch-shaped battery cells in large quantities.

### SUMMARY

It is an object of the present disclosure to provide a chain-linked cylindrical battery cell for battery packs capable of quickly assembling a battery pack with less labor. This is achieved by disposing a large number of cylindrical battery cells in a linear, parallel, or spiral structure at once, rather than by individually aligning and positioning cylindrical battery cells. Additionally, the configuration prevents electrical contact separation and short circuit due to mechanical impact applied in multiple directions.

The above object is accomplished by a chain-linked cylindrical battery cell for battery packs. The chain-linked cylindrical battery cell includes: a cylindrical cell having a cylindrical can in which a jelly-roll and an electrolyte are received and a top cap configured to seal the cylindrical can; and a first chain ring coupled to an outer circumferential surface of an upper end of the cylindrical can. The first chain ring has a pair of first coupling rings protruding from an outer circumferential surface thereof in opposite directions. The chain-linked cylindrical battery cell also includes a second chain ring coupled to an outer circumferential surface of a lower end of the cylindrical can. The second chain ring has a pair of second coupling rings protruding from an outer circumferential surface thereof in opposite directions. The chain-linked cylindrical battery cell also includes a chain pin configured to be inserted through the first coupling rings and adjacent first coupling rings of a similarly-configured battery cell and the second coupling rings and adjacent second coupling rings of the similarly-configured battery cell. The first coupling rings overlap with the adjacent first coupling rings, and the second coupling rings overlap with the adjacent second coupling rings.

The chain pin couples the battery cell to the similarly-configured battery cell based on a longitudinal direction of the cylindrical can and a longitudinal direction of an adjacent cylindrical can of the similarly-configured battery cell such as to rotatably connect the cylindrical can to the adjacent cylindrical can in a chain.

A first ring of the first coupling rings may be provided with a coupling protrusion formed parallel to a longitudinal direction of the cylindrical can. A second ring of the first coupling rings may be provided with a coupling recess into which an adjacent coupling protrusion of the similarly-configured battery cell is configured to be fitted.

A first coupling ring of the second coupling rings may be provided with a coupling protrusion formed parallel to a longitudinal direction of the cylindrical can. A second coupling ring of the second coupling rings may be provided with a coupling recess into which an adjacent coupling protrusion of the similarly-configured battery cell is configured to be fitted in.

The first chain ring may further include first parallel fixtures of complementary shapes protruding from the outer circumferential surface of the first chain ring and positioned orthogonal to the pair of the first coupling rings in opposite directions. The first parallel fixtures are configured to fix the cylindrical can to an adjacent cylindrical can of the similarly-configured battery cell, and the cylindrical can and the adjacent cylindrical can face each other while being positioned adjacent to each other based on parallel disposition.

The second chain ring may further include second parallel fixtures of complementary shapes protruding from the outer circumferential surface of the second chain ring and positioned orthogonal to the pair of the second coupling rings in opposite directions. The second parallel fixtures are configured to fix the cylindrical can to an adjacent cylindrical can of the similarly-configured battery cell and the cylindrical can and the adjacent cylindrical can face each other while being positioned adjacent to each other based on a parallel orientation.

The chain pin may further include fixing packs that extend from both ends of the chain pin and are configured to be embedded in inner circumferential surfaces of a battery pack frame and a battery pack cover in order to further fix the cylindrical cell.

The first chain ring may include a first circumferential member configured to be fitted so as to wrap around the outer circumferential surface of the upper end of the cylindrical can. The first chain ring may include a first support end jaw extending from the first circumferential member and configured to be fitted so as to wrap around and support an edge of an upper surface of the top cap.

The second chain ring may include a second circumferential member configured to be fitted so as to wrap around the outer circumferential surface of the lower end of the cylindrical can and a second support end jaw extending from the second circumferential member and configured to be fitted so as to wrap around and support an edge of a lower surface of the cylindrical can.

### BRIEF DESCRIPTION OF THE DRAWINGS

FIG. 1 is a perspective view showing a chain-linked cylindrical battery cell disposed in a line for battery packs according to an embodiment of the present disclosure;

FIG. 2 is an exploded perspective view of FIG. 1;

FIGS. 3A-3E show a process of manufacturing a chain-linked cylindrical battery cell for battery packs according to an embodiment of the present disclosure;

FIG. 4 is a view showing a process in which a chain-linked cylindrical battery cell for battery packs is assembled while being spirally disposed to constitute a disc-shaped battery pack according to an embodiment of the present disclosure;

FIG. 5 is a view showing a process in which a chain-linked cylindrical battery cell for battery packs is assembled while being disposed in parallel to constitute a quadrangular battery pack according to an embodiment of the present disclosure; and

FIG. 6 is a view showing a state in which a disc-shaped battery pack of FIG. 4 is mounted.

### DETAILED DESCRIPTION

Hereinafter, embodiments of the present disclosure are described in detail with reference to the accompanying drawings. However, in describing the present disclosure, descriptions of features or configurations that are already known in the art have been omitted in order to clarify the gist of the present disclosure.

When an element is referred to as being “connected to” or “coupled to” another element or layer, it may be directly connected to or coupled to the other element, or intervening elements may be present.

In contrast, when an element is referred to as being “directly connected to” or “directly coupled to” another element, there may be no intervening elements present.

In the following description of the embodiments of the present disclosure, the terms “comprises,” “comprising,” “including,” and “having” are inclusive and therefore indicate specific features, integers, steps, operations, elements, components, and/or combinations thereof, but do not preclude the presence or addition of one or more other features, integers, steps, operations, elements, components, and/or combinations thereof.

When a component, device, element, or the like of the present disclosure is described as having a purpose or performing an operation, function, or the like, the component, device, or element should be considered herein as being “configured to” meet that purpose or to perform that operation or function.

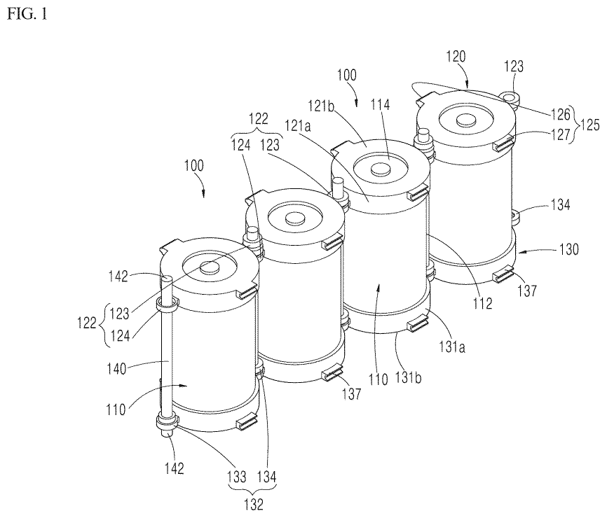

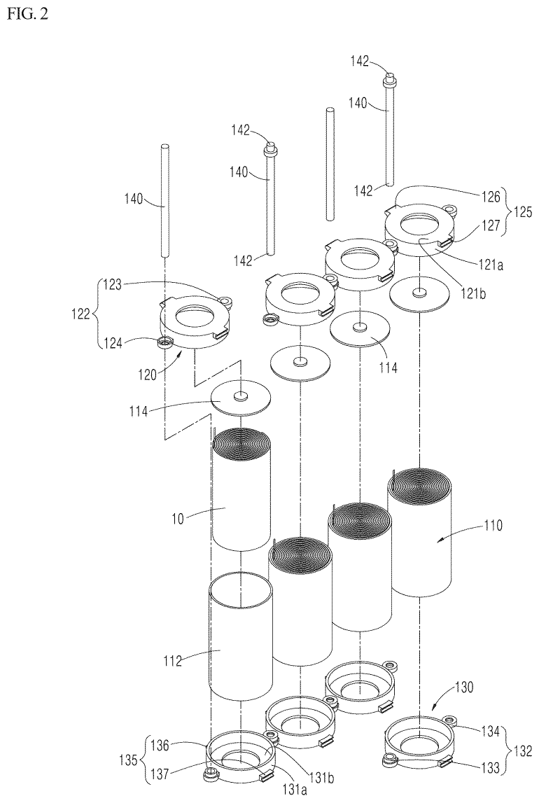

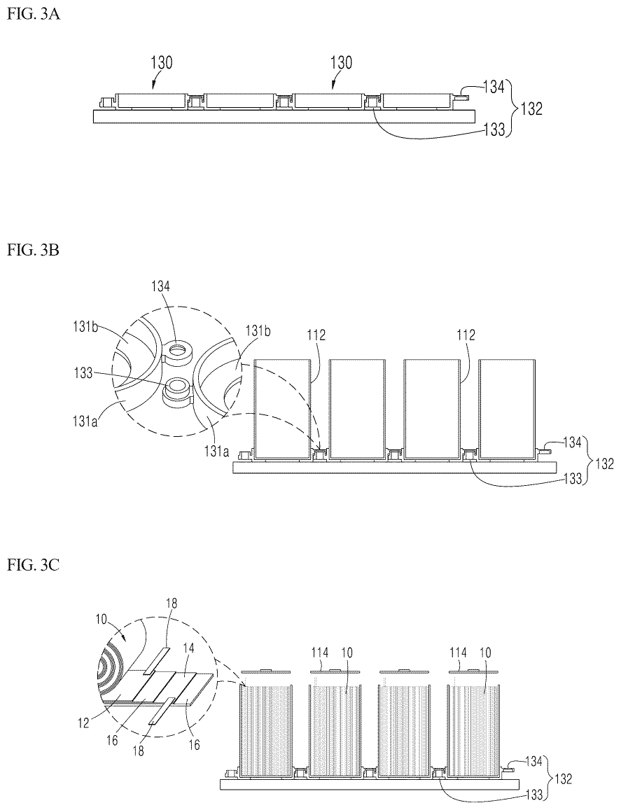

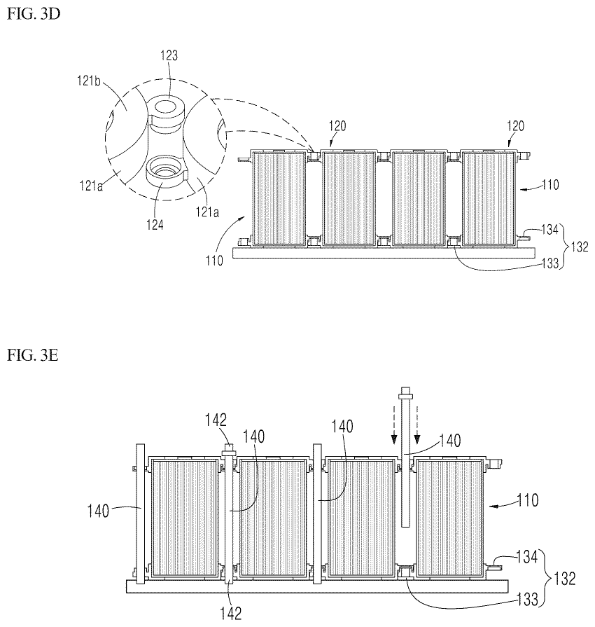

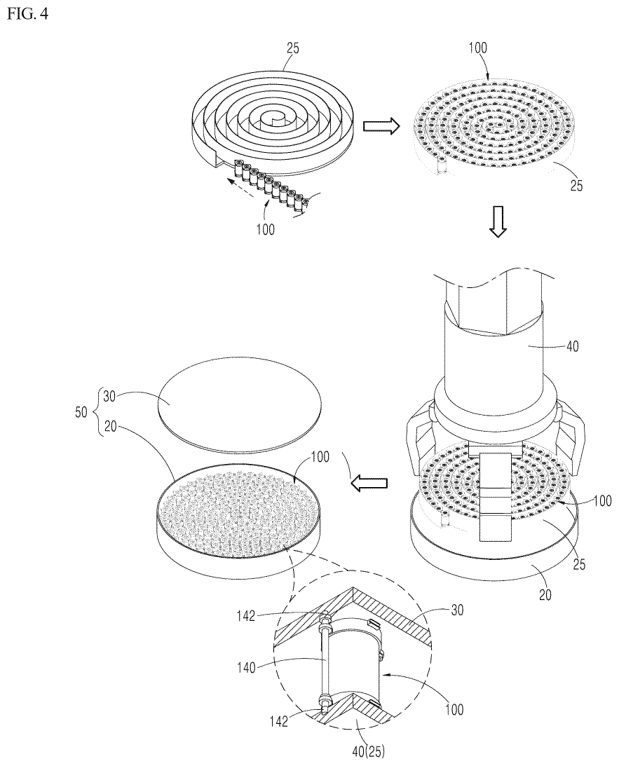

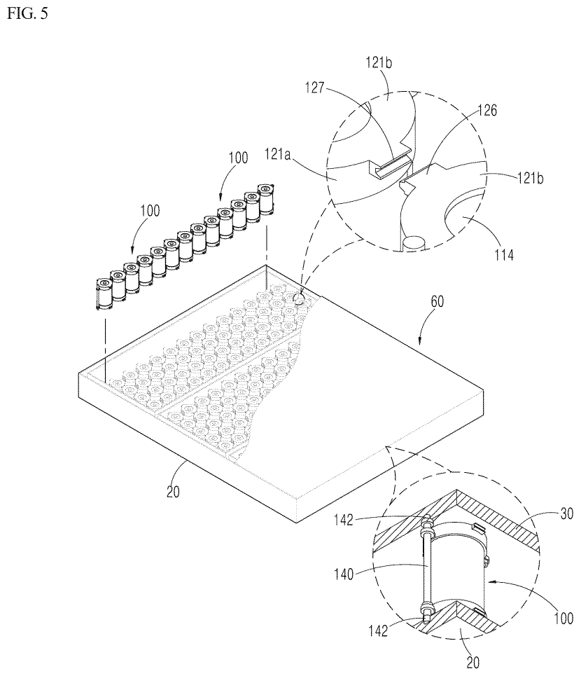

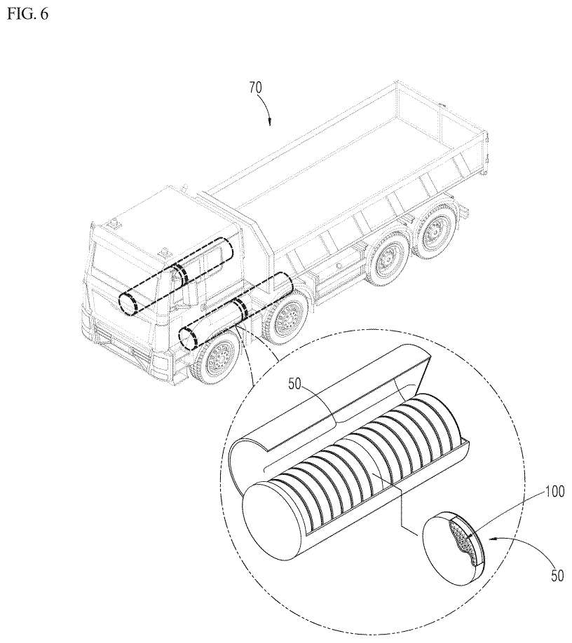

FIG. 1 is a perspective view showing that a chain-linked cylindrical battery cell for battery packs according to an embodiment of the present disclosure are disposed in a line. FIG. 2 is an exploded perspective view of FIG. 1. FIGS. 3A-3E are a process views showing steps of a process of manufacturing the chain-linked cylindrical battery cells for battery packs according to the embodiment of the present disclosure. FIG. 4 is a view showing a process in which the chain-linked cylindrical battery cell for battery packs according to the embodiment of the present disclosure is assembled while being spirally disposed to constitute a disc-shaped battery pack. FIG. 5 is a view showing a process in which the chain-linked cylindrical battery cell for battery packs according to the embodiment of the present disclosure is assembled while being disposed in parallel to constitute a quadrangular battery pack. FIG. 6 is a view showing the state in which the disc-shaped battery pack of FIG. 4 is mounted.

In the description of the disclosure and the claims, the terms upper (upward), lower (downward), left and right (side or lateral), before (front or forward), and after (rear or backward), which refer to orientation, are for convenience of description and not for the purpose of limitation of rights. Additionally, these terms are based on relative positions in the drawings and configurations, and three axes may be rotated to correspond to each other, unless otherwise specified.

The chain-linked cylindrical battery cell 100 for battery packs according to the present disclosure is configured to have a chain-linked structure in which cylindrical cells 110 are connected to each other in a line. As a result, the configuration allows for easy transportation and handling of a large number of cylindrical cells 110 used for assembling a battery pack 50 or 60 at one time. Additionally, the configuration enables various shapes of the battery pack 50 or 60 to be quickly assembled or manufactured with less labor by changing the chain arrangement or layout, and facilitates adjustment of the power capacity and size of the battery pack 50 or 60 by changing the length of the chains.

The battery pack 50 or 60 refers to a high-powered, large-scale battery assembly constituted by disposing a large number of battery cells in series or parallel in a protective frame, electrically connecting the battery cells to each other, and adding other electrical circuits and the like for high output voltage and power capacity.

In order to specifically realize the functions or operations as described above, a single chain-linked cylindrical battery cell 100 for battery packs according to the embodiment of the present disclosure is described. The chain-linked cylindrical battery cell 100 may include a cylindrical cell 110, a first chain ring 120, a second chain ring 130, and a chain pin 140, as shown in FIGS. 1 and 2.

Hereinafter, each of the above-described components are described in detail.

First, the cylindrical cell 110 may be a cylindrical secondary unit battery that may be used alone or in plural in a state of being connected in series or in parallel to constitute the high-output battery pack 50 or 60.

The cylindrical cell 110 includes a cylindrical can 112 in which a jelly-roll 10 including a positive electrode 12, a negative electrode 14, a separator 16, and a machined tab 18, and electrolyte are received and a top cap 114 configured to seal the cylindrical can 112. Additionally, the cylindrical cell 110 may be a cylindrical battery cell commercially available in various sizes, such as 18650, 21700, and 4680(0).

The first chain ring 120 is a component provided in conjunction with the second chain ring 130, which is described below, to mediate the connection of adjacent cylindrical cells 110 to each other in a chain-linked structure formed in a line at an upper end of the cylindrical cell 110. As a result, the cylindrical cells can be easily transported and handled at once, to rapidly assemble or manufacture the battery pack 50 or 60 in various shapes with less labor by changing the chain arrangement or layout, and to facilitate adjustment of the power capacity and size of the battery pack 50 or 60.

As shown in FIGS. 1 to 3, the first chain ring 120 is manufactured in the form of a ring that is coupled to an outer circumferential surface of an upper end of the cylindrical can 112, which is an outer cover of the cylindrical cell 110 described above. The first chain ring 120 may include a first circumferential member 121a, a first support end jaw 121b, a first coupling ring 122, and a first parallel fixture 125.

In this case, the first circumferential member 121a is a ring-shaped component that is fitted and fixed so as to wrap around the outer circumferential surface of the upper end of the cylindrical can 112. The first support end jaw 121b is a component that extends from the first circumferential member 121a described above so as to wrap around and support the edge of an upper surface of the top cap 114 described above.

The first coupling ring 122 is a component provided above the second coupling ring 132, which is described below, for connecting adjacent cylindrical cells 110 to each other in a chain-linked structure formed in a line through the penetrating installation of the chain pin 140, which is described below. The first coupling ring 122 may be formed by a pair of ring structures protruding from the outer circumferential surface, i.e., the first circumferential member 121a described above, in opposite directions.

In this case, one of the first coupling rings (e.g., a first of the first coupling rings) 122 may have a coupling projection 123 protruding parallel to a longitudinal direction of the cylindrical can 112 described above, as shown in FIGS. 2 and 3.

The other of the first coupling rings (e.g., a second of the first coupling rings) 122, which is located on the opposite side with respect to the first circumferential member 121a described above, may be provided with a coupling recess 124 into which another coupling protrusion 123 from an adjacent cylindrical cell 110, which is adjacent to the coupling recess and overlaps the coupling recess, is fitted.

Due to the coupling protrusion 123 and the coupling recess 124, which are configured to couple to each other by fitting, the cylindrical cells 110 adjacent to each other may be easily and quickly connected to each other. Additionally, the strength of the connection between the first coupling rings 122, through which the chain pin 140, which is described below, extends after overlapping each other, may be further increased, and the cylindrical cells 110 connected to each other may be more reliably rotated relative to each other without shaking.

The first parallel fixture 125 is a component configured to ensure that the plurality of cylindrical cells 110 connected in a line by the first coupling ring 122 described above and the cylindrical cells 110 adjacent to each other based on the parallel disposition as shown in FIG. 5 are coupled and fixed to each other.

The first parallel fixture 125 may be formed as the result of the pair of first coupling rings 122 protruding from the outer circumferential surface of the first chain ring 120. In other words, the first parallel fixture 125 is positioned orthogonal to the coupling protrusion 123 and the coupling recess 124, which are positioned in opposite directions to each other.

A fixing projection 126 may protrude from one side of the first parallel fixture 125 in a radial direction of the cylindrical can 112 described above, as shown in FIGS. 2 and 3.

The fixing protrusion 126 may be a horizontally flattened plate-like protrusion configured to allow for free relative rotation of the plurality of cylindrical cells 110 that are connected in a line by the first coupling ring 122 or the like described above.

A fixing recess 127 having a complementary shape, into which another fixing protrusion 126 of an adjacent cylindrical cell 100 is fitted, may be formed on the other side of the first parallel fixture 125, which is located on the opposite side with respect to the first circumferential member 121a described above.

The fixing recess 127 may be open so as not to constrain the end of the horizontally flattened fixing protrusion 126 in a width direction.

Due to the above fitting type of the first parallel fixture 125, which includes the fixing protrusion 126 and the fixing recess 127, the cylindrical cells 110 adjacent in a parallel direction may be easily and quickly connected to each other. Additionally, a large number of the cylindrical cells 110 disposed in a line and in parallel may be securely coupled or connected to each other by the coupling protrusion 123 and the coupling recess 124 of the first chain ring 120 described above.

The first chain ring 120, constituted by the above-described components, may be integrally manufactured by injection-molded engineering plastic such as polycarbonate (PC), acrylonitrile-butadiene-styrene (ABS), or polybutylene terephthalate (PBT). These amorphous resins have excellent heat resistance, flame retardancy, insulation, wear resistance, impact resistance, and the like. Alternatively, the first chain ring 120 may be manufactured by pressing or die-casting a lightweight metal.

The second chain ring 130 is a component provided in conjunction with the first chain ring 120 described above to mediate the connection of adjacent cylindrical cells 110 to each other in a chain-linked structure formed in a line at a lower end of the cylindrical cell 110. As a result, the cylindrical cells can be easily transported and handled at once, allowing for the rapid assemble or manufacture of the battery pack 50 or 60 in various shapes with less labor. This is achieved by changing the chain arrangement or layout, which also facilitates the adjustment of the power capacity and size of the battery pack 50 or 60.

As shown in FIGS. 1 to 3, the second chain ring 130 is manufactured in the form of a ring that is coupled to an outer circumferential surface of a lower end of the cylindrical can 112, which is the outer cover of the cylindrical cell 110 described above. The second chain ring 130 may include a second circumferential member 131a, a second support end jaw 131b, a second coupling ring 132, and a second parallel fixture 135.

In this case, the second circumferential member 131a is a ring-shaped component that is fitted and fixed so as to wrap around the outer circumferential surface of the lower end of the cylindrical can 112. The second support end jaw 131b is a component that extends from the second circumferential member 131a described above so as to wrap around and support the edge of a lower surface of the cylindrical can 112.

The second coupling ring 132 is a component provided under the first coupling ring 122 described above for connecting the cylindrical cells 110 adjacent to each other in a chain-linked structure formed in a line through the penetrating installation of the chain pin 140, which is described below. The second coupling ring 132 may be formed by a pair of ring structures protruding from the outer circumferential surface, i.e., the second circumferential member 131a described above, in opposite directions.

In this case, one of the second coupling rings (e.g., a first of the second coupling rings) 132 may have a coupling projection 133 protruding parallel to the longitudinal direction of the cylindrical can 112 described above, as shown in FIGS. 2 and 3.

The other of the second coupling rings (e.g., a second of the second coupling rings) 132, which is located on the opposite side with respect to the second circumferential member 131a described above, may be provided with a coupling recess 134 into which another coupling protrusion 133 of an adjacent cylindrical cell 110, which is adjacent to the coupling recess and overlaps the coupling recess, is fitted.

Due to the coupling protrusion 133 and the coupling recess 134, which are configured to be couple to each other by fitting, the cylindrical cells 110 adjacent to each other may be easily and quickly connected to each other. As a result, the strength of the connection between the second coupling rings 132, through which the chain pin 140, which is described below, extends after overlapping each other, may be further increased, and the cylindrical cells 110 connected to each other may be more reliably rotated relative to each other without shaking.

The second parallel fixture 135 is a component configured to ensure that the plurality of cylindrical cells 110 that are connected in a line by the second coupling ring 132 and the cylindrical cells 110 that are adjacent to each other based on the parallel disposition as shown in FIG. 5 are coupled and fixed to each other, and may be disposed under the first parallel fixture 125.

The second parallel fixture 135 may be formed as the result of the pair of second coupling rings 132 protruding from the outer circumferential surface of the second chain ring 130. In other words, the second parallel fixture 135 is positioned orthogonal to the coupling protrusion 133 and the coupling recess 134, which are positioned in opposite directions to each other.

A fixing projection 136 may protrude from one side of the second parallel fixture 135 in the radial direction of the cylindrical can 112 described above, as shown in FIGS. 2 and 3.

The fixing protrusion 136 may be a horizontally flattened plate-like protrusion configured to allow for free relative rotation of the plurality of cylindrical cells 110 that are connected in a line by the second coupling ring 132 or the like described above.

A fixing recess 137 having a complementary shape, into which another fixing protrusion 136 of an adjacent cylindrical cell 110 is fitted into, may be formed in the other side of the second parallel fixture 135, which is located on the opposite side with respect to the second circumferential member 131a described above.

The fixing recess 137 may be open so as not to constrain the end of the horizontally flattened fixing protrusion 126 as described above in the width direction.

Due to the above fitting type of the second parallel fixture 135, which includes the fixing protrusion 136 and the fixing recess 137, the cylindrical cells 110 adjacent in the parallel direction may be easily and quickly connected to each other. As a result, a large number of cylindrical cells 110 disposed in a line and in parallel may be securely coupled or connected to each other by the coupling protrusion 133 and the coupling recess 134 of the second chain ring 130 described above.

The second chain ring 130, constituted by the above-described components, may be integrally manufactured by injection-molded engineering plastic such as polycarbonate (PC), acrylonitrile-butadiene-styrene (ABS), or polybutylene terephthalate (PBT). These amorphous resins have excellent heat resistance, flame retardancy, insulation, wear resistance, impact resistance, and the like. Alternatively, the second chain ring 130 may be manufactured by pressing or die-casting lightweight metal, in the same manner as the first chain ring 120.

The chain pin 140 is a component configured to rotatably connect adjacent cylindrical cells 110 to each other in a chain together with the first and second coupling rings 122 and 132 described above.

The chain pin 140 may be constituted by a rod member installed through the first and second coupling rings 122 and 132, which overlap adjacent coupling rings 122 and 132 of an adjacent cylindrical cell 110. In other words, the first and second coupling rings 122 and 132 overlap with each other while being adjacent to each other, in parallel to the longitudinal direction of the cylindrical can 112 based on the disposition of the cylindrical cells 110 in a line, as shown in FIGS. 2 and 3.

In this case, the chain pins 140 may include fixing packs 142 that extend from both ends of each respective chain pin 140. The fixing packs 142 are embedded in an inner circumferential surface of a battery pack frame 20 or a battery pack cover 30, as shown in FIGS. 4 and 5, in order to further fix the plurality of cylindrical cells 110 disposed in a line and in parallel to constitute the battery pack 50 or 60.

Due to the chain pin 140 as described above, the strength of the connection between the first and second coupling rings 122 and 132 disposed in a line and coupled by fitting may be further increased, the separation between the first and second coupling rings 122 and 132 may be suppressed, and the relative rotation between the cylindrical cells 110 disposed in a line may be freely and reliably achieved.

As shown in FIGS. 3A-3E, the chain-linked cylindrical battery cell 100 according to the disclosure described above may be manufactured by continuously providing interconnected second chain rings 130 to a production line using a conventional cylindrical battery cell manufacturing process (FIG. 3A), manufacturing cylindrical cells 110 on the provided second chain rings 130 (FIGS. 3B and 3C), coupling interconnected first chain rings 120 to upper ends of the manufactured cylindrical cells 110 (FIG. 3D), and installing chain pins 140 through the first and second chain rings 120 and 130 (FIG. 3E).

As shown in FIG. 4, a large number of cylindrical cells 110, which are continuously manufactured in a chain-linked structure formed in a line as described above, enter one side of a guide frame 25 formed in the shape of a spiral disc without being transported separately, are arranged in a spiral shape. The cylindrical cells 110 are transferred to the disc-shaped battery pack frame 20 via a robot arm 40 or the like all at once. Electrical circuits and electrical wires are added, and sealing is performed by the battery pack cover 30, whereby a disc battery pack 50 may be quickly formed with less labor.

In addition, as shown in FIG. 6, a plurality of disc battery packs 50 may be connected to an electric vehicle 70 or the like in series such that the power capacity and size thereof can be easily adjusted.

In addition, as shown in FIG. 5, a large number of cylindrical cells 110, which are continuously manufactured in a chain-linked structure formed in a line, may enable a quadrangular battery pack 60 to be quickly formed with less labor through a series of processes in which lines of cylindrical cells 110 are repeatedly disposed in a quadrangular battery pack frame 20 in parallel. The cylindrical cells 110 are manufactured so as to have a certain length. Electrical circuits and electrical wires are added, and sealing is performed using the battery pack cover 30, as shown in FIG. 5.

According to the present disclosure, a pair of first coupling rings protrudes from a first chain ring coupled to an outer circumferential surface of an upper end of a cylindrical cell that is sealed by a top cap after a jelly-roll and an electrolyte are inserted thereinto. The pair of first coupling rings protrude in opposite directions of each other. Similarly, a pair of second coupling rings protrudes from a second chain ring coupled to an outer circumferential surface of a lower end of a cylindrical can in opposite directions.

A chain pin is inserted through the first and second coupling rings aligned with corresponding first and second coupling rings of adjacent cylindrical cells. As a result, the first and second coupling rings of adjacent cylindrical cells overlap each other, forming a chain connection along the longitudinal direction of the cylindrical cans of the corresponding cylindrical cells. This configuration allow multiple cylindrical cells aligned in a row to be easily transported and handled together. Additionally, the interconnected cells can be arranged in a straight or quadrangular battery pack—either in a line or in parallel—or may be easily disposed in a circular or oval battery pack in a spiral structure while being freely rotated about a longitudinally parallel rotation axis. As a result, various types of battery packs may be quickly assembled or manufactured with less labor.

In addition, as the plurality of cylindrical cells is connected to each other in a chain-linked structure, electrical contact separation or short circuit due to mechanical impact applied from the outside may be effectively suppressed, and the cylindrical cells may be disposed in various lengths and arrangements as needed, thereby facilitating adjustment of the power capacity and size of the battery pack.

It should be apparent to a person having ordinary skill in the art that, although the specific embodiments of the present disclosure have been shown and described above, the present disclosure is not limited to the described embodiments and various changes and modifications are possible without departing from the idea and scope of the present disclosure. Thus, it is intended that the changes or the modifications should not be understood independently of the technical spirit or prospect of the present disclosure and that modified embodiments fall within the scope of the claims of the present disclosure.

What is claimed is:

1. A chain-linked cylindrical battery cell for battery packs, the battery cell comprising:
a cylindrical cell comprising a cylindrical can in which a jelly-roll and an electrolyte are received and a top cap configured to seal the cylindrical can;
a first chain ring coupled to an outer circumferential surface of an upper end of the cylindrical can, the first chain ring having a pair of first coupling rings protruding from an outer circumferential surface of the first chain ring in opposite directions;
a second chain ring coupled to an outer circumferential surface of a lower end of the cylindrical can, the second chain ring having a pair of second coupling rings protruding from an outer circumferential surface of the second chain ring in opposite directions; and
a chain pin configured to be inserted through the first coupling rings and adjacent first coupling rings of a similarly-configured battery cell and the second coupling rings and adjacent second coupling rings of the similarly-configured battery cell,
wherein the first coupling rings overlap with the adjacent first coupling rings, and
wherein the second coupling rings overlap with the adjacent second coupling rings.

2. The battery cell of claim 1, wherein the chain pin couples the battery cell to the similarly-configured battery cell based on a longitudinal direction of the cylindrical can and a longitudinal direction of an adjacent cylindrical can of the similarly-configured battery cell such as to rotatably connect the cylindrical can to the adjacent cylindrical can in a chain.

3. The battery cell of claim 1, wherein:
a first ring of the first coupling rings is provided with a coupling protrusion formed parallel to a longitudinal direction of the cylindrical can; and
a second ring of the first coupling rings is provided with a coupling recess into which an adjacent coupling protrusion of the similarly-configured battery cell is configured to be fitted in.

4. The battery cell of claim 1, wherein:
a first coupling ring of the second coupling rings is provided with a coupling protrusion formed parallel to a longitudinal direction of the cylindrical can; and
a second coupling ring of the second coupling rings is provided with a coupling recess into which an adjacent coupling protrusion of the similarly-configured battery cell is configured to be fitted in.

5. The battery cell of claim 1, wherein the first chain ring further comprises:
first parallel fixtures of complementary shapes protruding from the outer circumferential surface of the first chain ring and positioned orthogonal to the pair of the first coupling rings in opposite directions,
wherein the first parallel fixtures are configured to fix the cylindrical can to an adjacent cylindrical can of the similarly-configured battery cell, and
wherein the cylindrical can and the adjacent cylindrical can face each other while being positioned adjacent to each other based on a parallel orientation.

6. The battery cell of claim 1, wherein the second chain ring further comprises:
second parallel fixtures of complementary shapes protruding from the outer circumferential surface of the second chain ring and positioned orthogonal to the pair of the second coupling rings in opposite directions,
wherein the second parallel fixtures are configured to fix the cylindrical can to an adjacent cylindrical can of the similarly-configured battery cell, and
wherein the cylindrical can and the adjacent cylindrical can face each other while being positioned adjacent to each other based on a parallel orientation.

7. The battery cell of claim 1, wherein the chain pin further comprises:
fixing packs that extend from both ends of the chain pin and are configured to be embedded in inner circumferential surfaces of a battery pack frame and a battery pack cover in order to further fix the cylindrical cell.

8. The battery cell of claim 1, wherein the first chain ring comprises:
a first circumferential member configured to be fitted so as to wrap around the outer circumferential surface of the upper end of the cylindrical can; and
a first support end jaw extending from the first circumferential member and configured to be fitted so as to wrap around and support an edge of an upper surface of the top cap.

9. The battery cell of claim 1, wherein the second chain ring comprises:
a second circumferential member configured to be fitted so as to wrap around the outer circumferential surface of the lower end of the cylindrical can; and
a second support end jaw extending from the second circumferential member and configured to be fitted so as to wrap around and support an edge of a lower surface of the cylindrical can.

10. The battery cell of claim 1, wherein the first chain ring and the second chain ring are integrally manufactured by injection-molded engineering plastic comprising polycarbonate (PC), acrylonitrile-butadiene-styrene (ABS), or polybutylene terephthalate (PBT).

11. A chain-linked cylindrical battery cell system for battery packs, the battery cell system comprising:
a plurality of battery cells coupled to each other in a chain, each battery cell of the plurality of battery cells comprises:
a cylindrical cell comprising a cylindrical can in which a jelly-roll and an electrolyte are received and a top cap configured to seal the cylindrical can;
a first chain ring coupled to an outer circumferential surface of an upper end of the cylindrical can, the first chain ring having a pair of first coupling rings protruding from an outer circumferential surface of the first chain ring in opposite directions;
a second chain ring coupled to an outer circumferential surface of a lower end of the cylindrical can, the second chain ring having a pair of second coupling rings protruding from an outer circumferential surface of the second chain ring in opposite directions; and
a chain pin configured to be inserted through the first coupling rings and the second coupling rings,
wherein a first coupling ring of a pair of first coupling rings of a first battery cell overlaps with a first coupling ring of a pair of first coupling rings of a second battery cell, and
wherein a second coupling ring of a pair of second coupling rings of the first battery cell overlaps with a second coupling ring of a pair of second coupling rings of the second battery cell.

12. The battery cell system of claim 11, wherein the chain pin couples the first battery cell to the second battery cell based on a longitudinal direction of a first cylindrical can of the first battery cell and a longitudinal direction of a second cylindrical can of the second battery cell such as to rotatably connect the first cylindrical can to the second cylindrical can in a chain.

13. The battery cell system of claim 11, wherein each battery cell of the plurality of battery cells further comprises:
a first ring of the first coupling rings having a coupling protrusion formed parallel to a longitudinal direction of the cylindrical can; and
a second ring of the first coupling rings having a coupling recess into which a coupling protrusion of a similarly-configured battery cell is configured to be fitted in.

14. The battery cell system of claim 11, wherein each battery cell of the plurality of battery cells further comprises:
a first coupling ring of the second coupling rings having a coupling protrusion formed parallel to a longitudinal direction of the cylindrical can; and
a second coupling ring of the second coupling rings having a coupling recess into which a coupling protrusion of a similarly-configured battery cell is configured to be fitted in.

15. The battery cell system of claim 11, wherein the first chain ring of each battery cell of the plurality of battery cells further comprises:
first parallel fixtures of complementary shapes protruding from the outer circumferential surface of the first chain ring and positioned orthogonal to the pair of the first coupling rings in opposite directions,
wherein the first parallel fixtures are configured to fix the cylindrical can to an adjacent cylindrical can of a similarly-configured battery cell.

16. The battery cell system of claim 11, wherein the second chain ring of each battery cell of the plurality of battery cells further comprises:
second parallel fixtures of complementary shapes protruding from the outer circumferential surface of the second chain ring and positioned orthogonal to the pair of the second coupling rings in opposite directions,
wherein the second parallel fixtures are configured to fix the cylindrical can to an adjacent cylindrical can of a similarly-configured battery cell.

17. The battery cell system of claim 11, wherein the chain pin of each battery cell of the plurality of battery cells further comprises:
fixing packs that extend from both ends of the chain pin and are configured to be embedded in inner circumferential surfaces of a battery pack frame and a battery pack cover in order to further fix the cylindrical cell.

18. The battery cell system of claim 11, wherein the first chain ring of each battery cell of the plurality of battery cells further comprises:
a first circumferential member configured to wrap around the outer circumferential surface of the upper end of the cylindrical can; and
a first support end jaw extending from the first circumferential member and configured to wrap around and support an edge of an upper surface of the top cap.

19. The battery cell system of claim 11, wherein the second chain ring of each battery cell of the plurality of battery cells further comprises:
a second circumferential member configured to wrap around the outer circumferential surface of the lower end of the cylindrical can; and
a second support end jaw extending from the second circumferential member and configured to wrap around and support an edge of a lower surface of the cylindrical can.

20. The battery cell system of claim 11, wherein the first chain ring and the second chain ring are integrally manufactured by injection-molded engineering plastic comprising polycarbonate (PC), acrylonitrile-butadiene-styrene (ABS), or polybutylene terephthalate (PBT).
